(19) United States
(12) Patent Application Publication
(10) Pub. No.: US 2015/0230665 A1
(43) Pub. Date: Aug. 20, 2015

(54) Cool Knob

(71) Applicant: Wayne Denny, Reno, NV (US)

(72) Inventor: Wayne Denny, Reno, NV (US)

(21) Appl. No.: 14/184,926

(22) Filed: Feb. 20, 2014

(51) Int. Cl. A47J 45/08; A47J 45/06

(52) U.S. Cl. CPC A47J 45/08; A47J 45/063

(57) ABSTRACT

This invention involves knobs that prevent cookware lids from becoming hot and burning users when food is being cooked in the cookware. The Cool Knob System comprises a knob coupled to a cookware lid; a metallic exterior layer; a screw; and an interior fill consisting of a non-conductive material, wherein the exterior metallic layer covers the interior fill, thereby providing a knob with a metallic appearance while maintaining a non-conductive quality. The metallic layer completely covers the interior fill such that the interior fill is not visible, and may be made of stainless steel or polished stainless steel. The interior fill may be made of silicone or another appropriate non-conductive material.

### CLAIM TO PRIORITY OF EARLIER FILED APPLICATION(S)

None.

### CROSS-REFERENCE TO EARLIER FILED APPLICATION(S)

None.

### FIELD OF THE INVENTION

The present invention relates to knobs generally for use with cookware lids.

BACKGROUND OF THE INVENTION

This invention relates to knobs coupled to cookware lids. Cookware lids are placed on pots, pans, saucepans, skillets, and other cookware to retain heat when food is being cooked in the cookware. The cookware lids retains heat and cause the contents of the cookware to heat more quickly during the cooking process; however, the knobs coupled to the cookware lids also may become hot when food is being cooked in the cookware. As a result, cookware users sometimes are burned by hot knobs coupled to cookware lids when food is being cooked in the cookware. A common and simple solution to this problem is the use of knobs made of non-conductive material. Silicone and various types of polymers are often used as material for the knob. However, many consumers prefer the attractive appearance of the stainless steel. Over the last 20 years or so stainless steel appliances and kitchenware have become “in vogue” according to most realtors and kitchen fashion magazines and websites. Currently, many realtors advise their clients to make sure they replace any non-stainless appliances and kitchenware with stainless ones prior to showing the home to potential buyers. The cost of doing this is thought to be far outweighed by the increased sale value of being all stainless in the kitchen.

### Advantages of the Invention

One of the advantages of this invention is that it prevents knobs coupled to cookware lids from becoming hot and potentially burning the user when food is being cooked in the cookware. Another one of the advantages of this invention is that maintains the attractive and stylish stainless look.

### SUMMARY OF THE INVENTION

Quite simply, the present invention provides the attractive and stylish appearance of stainless steel while maintaining the heat insulation of a polymer handle. The Cool Knob System comprise a knob coupled to a cookware lid; a metallic exterior layer; a screw; and an interior fill consisting of a non-conductive material, wherein the exterior metallic layer covers the interior fill, thereby providing a knob with a metallic appearance while maintaining a non-conductive quality. The metallic layer completely covers the interior fill such that the interior fill is not visible, and may be made of stainless steel or polished stainless steel. The interior fill may be made of silicone or another appropriate non-conductive material. The knob may be connected to the cookware lid by a screw, wherein the screw passes from an underside of the cookware lid through the cookware lid, and then into the middle of an underside of the knob. The knob is placed in the center of the cookware lid. The cookware lid is made of glass and the knob may preferably be connected to the cookware lid so that the interior fill contacts the cookware lid but the exterior metallic layer does not contact the cookware lid.

### BRIEF DESCRIPTION OF THE DRAWINGS

FIG. 1 is substantially a side perspective view of the preferred embodiment of the present invention.

FIG. 2 is substantially a top perspective view of the present invention.

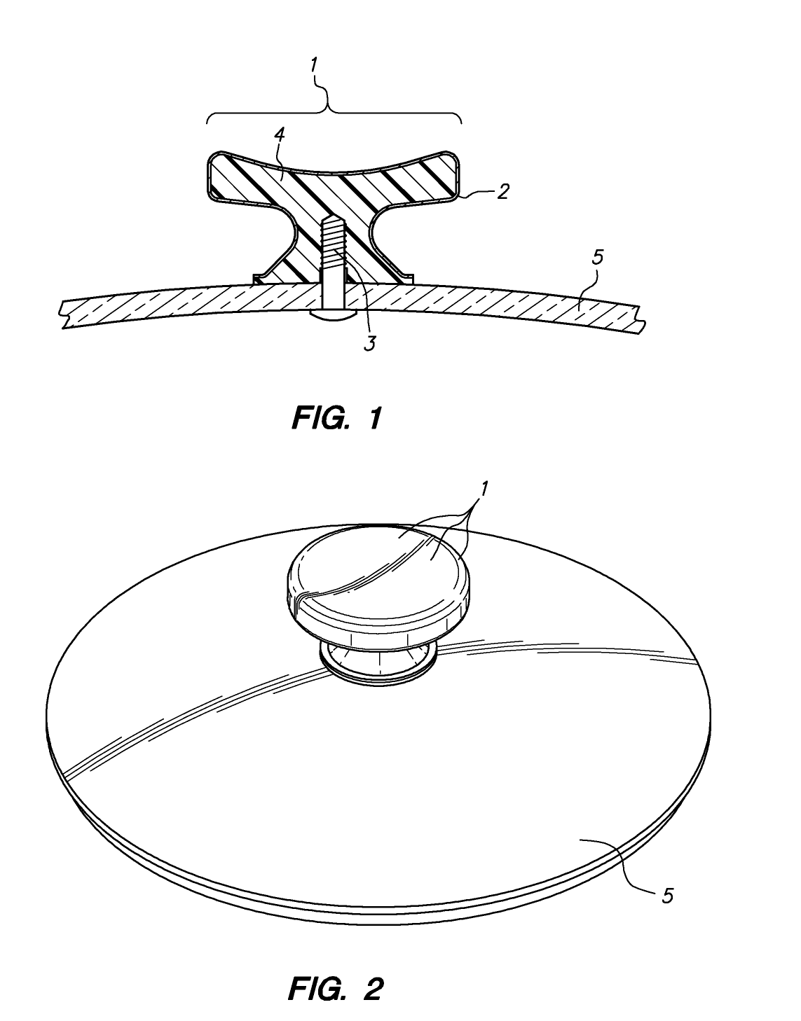

### DETAILED DESCRIPTION OF THE INVENTION

In the following detailed description of the preferred embodiment, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The following is a listing of the reference numbers included in the original drawings and the element that each reference number corresponds to and a brief description:

1. Cool Knob. The Cool Knob 1 includes a Metal Exterior 2, a Screw 3, Silicone Fill 4, and a Cookware Lid 5. The Cookware Lid 5 may be made of glass, stainless steel, or other material. The Cool Knob 1 may be connected to the Cookware Lid 5 so that the Silicone Fill 4 contacts the Cookware Lid 5 but the Metal Exterior 2 does not contact the Cookware Lid 5.

2. Metal Exterior. The Metal Exterior 2 is a metallic layer that completely covers the Silicone Fill 4 such that the Silicone Fill 4 is not visible. The Metal Exterior 2 is preferably made of stainless steel or polished stainless steel.

3. Screw. The Cool Knob 1 is connected to the Cookware Lid 5 by a Screw 3, wherein the Screw 3 passes from an underside of the Cookware Lid 5 through the Cookware Lid 5, and then into the middle of an underside of the Cool Knob 1. The Cool Knob 1 is placed in the center of the Cookware Lid 5.

4. Non-Conductive Fill. The Non-Conductive Fill 4 may be made of silicone or other suitable non-conductive material. The Metal Exterior 2 completely covers the Non-Conductive Fill 4 such that the Fill 4 is not visible.

5. Cookware Lid. The Cookware Lid 5 may be made of glass, stainless steel, or other appropriate material. The Cool Knob 1 may be connected to the Cookware Lid 5 so that the Non-Conductive Fill 4 contacts the Cookware Lid 5 but the Metal Exterior 2 does not contact the Cookware Lid 5.

A preferred embodiment of the present invention comprises a Cool Knob 1 coupled to a Cookware Lid 5; a Metal Exterior 2, which consists of a metallic exterior layer made of stainless steel or polished stainless steel; a Screw 3; and Silicone Fill 4, which consists of a non-conductive material. In the preferred embodiment of the present invention, the Metal Exterior 2 covers the Silicone Fill 4, thereby providing a Cool Knob 1 with a metallic appearance, while maintaining a non-conductive quality. The Metal Exterior 2 completely covers the Non-Conductive Fill 4, such that the Non-Conductive Fill 4 is not visible. The Cool Knob 1 is connected to the Cookware Lid 5 by a Screw 3, wherein the screw passes from an underside of the Cookware Lid 5 through the Cookware Lid 5, and then into the middle of an underside of the Cool Knob 1. The Cool Knob 1 is placed in the center of the Cookware Lid 5. The Cool Knob 1 is connected to the Cookware Lid so that the Silicone Fill 4 contacts the Cookware Lid 5 but the Metal Exterior 2 does not contact the Cookware Lid 5.

Although the present invention has been explained in relation to its preferred embodiment, it is to be understood that many other possible modifications and variations can be made without departing from the spirit and scope of the present invention.

What is claimed is:

1. A cool knob system comprising:
a. a knob coupled to a cookware lid;
b. a metallic exterior layer;
c. an interior fill, the fill being made of a non-conductive material;
d. wherein the exterior metallic layer covers the interior fill thereby providing a knob with a metallic appearance while maintaining a non-conductive quality.

2. The system of claim 1, wherein the metallic layer completely covers the interior fill such that the interior fill is not visible.

3. The system of claim 1, wherein the metallic layer is made of stainless steel.

4. The system of claim 1, wherein the metallic layer is made of polished stainless steel.

5. The system of claim 1, wherein the interior fill is made of silicone.

6. The system of claim 1, wherein the metallic layer is made of stainless steel and the interior fill is made of silicone.

7. The system of claim 1, wherein the knob is connected to the cookware lid by a screw.

8. The system of claim 7, wherein the screw passes from an underside of the cookware lid through the cookware lid, and then into the middle of an underside of the knob.

9. The system of claim 8, wherein the knob is placed in the center of the cookware lid.

10. The system of claim 1, wherein the cookware lid is made of glass and the knob is connected to the cookware lid so that the interior fill contacts the cookware lid but the exterior metallic layer does not contact the cookware lid.
